(19) United States
(12) Patent Application Publication
(10) Pub. No.: US 2018/0275356 A1
(43) Pub. Date: Sep. 27, 2018

(54) OPTICAL SHUFFLE CABLE, CABLE ASSEMBLY, AND METHODS OF MAKING THE SAME

(71) Applicant: Corning Optical Communications LLC, Hickory, NC (US)

(72) Inventors: Yao Li, Newark, CA (US); Gang Xu, Dongguan (CN)

(21) Appl. No.: 15/915,198

(22) Filed: Mar. 8, 2018

Related U.S. Application Data
(60) Provisional application No. 62/513,101, filed on May 31, 2017.
(60) Provisional application No. 62/474,783, filed on Mar. 22, 2017.

(51) Int. Cl. G02B 6/38; G02B 6/44

(52) U.S. Cl. CPC G02B 6/3885; G02B 6/4403; G02B 6/443

(57) ABSTRACT

An optical shuffle cable comprises a first cable section, a second cable section, and an intermediate cable section between the first and second cable sections. The first cable section includes a plurality of optical fibers formed as a plurality of first optical fiber ribbons. The plurality of first optical fiber ribbons are stacked to arrange the plurality of optical fibers of the first cable section in a first array. The second cable section includes a plurality of optical fibers formed as a plurality of second optical fiber ribbons. The plurality of second optical fiber ribbons are stacked to arrange the plurality of optical fibers of the second cable section in a second array. The first and second arrays have respective first and second orientations that are perpendicular to each other such that the plurality of first optical fiber ribbons and the plurality of second optical fiber ribbons are shuffled between the first and second orientations within the intermediate cable section. Related cable assemblies and methods are also disclosed.

### CROSS-REFERENCE TO RELATED APPLICATIONS

This application claims the benefit of priority of U.S. Provisional Application Ser. No. 62/513,101, filed on May 31, 2017, and U.S. Provisional Application Ser. No. 62/474,783, filed on Mar. 22, 2017, the entire disclosures of which are fully incorporated herein by reference.

### BACKGROUND

In a telecommunications network, there are often locations where many input ports each need to be connected to many output ports. This is particularly the case in data centers, where various architectures have been developed to provider server-to-server connectivity. Many architectures are based on the principles of a “Clos network”, which was first developed in the 1950's as a method to switch telephone calls through network equipment in a manner that allows the calls to always remain connected; none of the calls are blocked by another call being transferred through the network. The method is named after Charles Clos, a researcher for Bell Laboratories, who first published information describing the method.

The Clos network is the foundation of a class of non-blocking switching architectures in today's data centers. For an interconnect task of N input and N output ports, Charles Clos proved that instead of using a single switching step to realize a totally interconnected network (switching complexity of N×N, or N²), trade-offs can be made to lower the switching complexity by increasing switching latency. Clos further showed that one can use an array of smaller switches, with the array having a switching complexity of the degree of N^{1/2}, to make a non-blocking network in three steps. This discovery was significant due to the fact that as N increases, the use of a large switch becomes increasingly expensive. For example, for N nodes to establish a non-blocking interconnect, one needs to equip each of the N nodes with a degree of N switches so that a total of N×N switching points must be used. However, by compromising switch latency from 1-step to 3-steps, each of the N nodes only needs to use a degree of N^{1/2} switches so that a total of N^{3/2} switching points are needed, thereby saving both switching power and allowing cheaper and smaller switches to be used. As N gets larger, the use of a Clos network becomes more practical.

FIG. 1 shows an example of a Clos network 10 with 16 nodes N (i.e., N=16) to illustrate the non-blocking networking concept. Instead of using a direct or single step crossbar switch of 16×16 in scale, the Clos network 10 in FIG. 1 uses three layers (“stages”) 12 of switches S sandwiched by two passive interconnects of “shuffles” 14 so that each switch S is a 4×4 switch. In FIG. 1, each switch S is shown as a solid rectangle, and the shuffles 14 between adjacent switching stages 12 are each shown as lines between the rectangles of the switching stages 12.

One of the ways that modern data centers implement shuffles of optical links is by using optical backplanes. FIG. 2 illustrates an example of such an optical backplane (denoted with reference number 20) that may used to interconnect input and outputs on one system card 22 (computing board with transceivers 24) with inputs and outputs on another system card, thereby serving as an optical shuffle device. An electrical/mechanical backplane 26 serves as an interface between the system card 22 and the optical backplane 20. Only one system card 22 is shown in FIG. 2, but other similar cards may interface with the optical backplane 20 and electrical/mechanical backplane 26 in a similar manner to exchange data between the cards using the optical backplane 20. In this example, the optical backplane 20 itself is formed as a laminated polymer board, a concept that was introduced in the 1990's. Optical fibers are sandwiched between laminating plastic sheets after being routed between input and output positions (“ports”) 28 located at the edges of the sheets. More specifically, for each specific design of interconnect pattern, a robotic fiber feeding arm is typically used to lay each optical fiber from an input port position to an output port position along a pre-designed routing pattern, one after another until the all the optical fibers are populated a pressure-sensitive adhesive layer of one of the laminating plastic sheets. The other laminating plastic sheet, which also contains a pressure-sensitive adhesive layer, is then placed on top of the optical fibers to sandwich the quasi-2D fiber routing pattern. Finally, all optical fibers 30 sticking out of the edges from their port positions are terminated with fiber optic connectors (hidden in FIG. 2; behind the electrical/mechanical backplane 26), which may be array connectors (e.g., MPO connectors) or single fiber connectors (e.g., LC connectors).

One drawback of flexible optical backplanes is that since the optical fibers between the laminating plastic sheets cross each other, when handling such a flexible laminated board, external pressure can cause fiber breakages at the crossing locations. Another drawback is that as fiber counts increase, the serial nature of the fiber layout or mapping on the 2D laminating sheet can consume serious assembly or manufacturing time.

FIG. 3 illustrates another example of an optical backplane 40 as an optical shuffle device. Instead of using a flexible polymer board, the optical backplane 40 in FIG. 3 uses a centralized patch panel block 42 (schematically illustrated) with differently oriented connector adapters on each side. This design is primarily intended for applications using array connections such as optical fiber ribbons for linking various computing boards. Optical fiber ribbons 44 each carrying parallel data to be exchanged between sources and destinations are brought to the patch panel block 42 from two opposite sides. The patch panel block 42 is designed in such a way that one side of it can accept connectors 46 with the optical fiber ribbons 44 in horizontal layout orientation, while the other side accepts connectors 48 with the optical fiber ribbons 44 in vertical layout orientation. Using this mutually perpendicular mating pattern, optical connections made using the patch panel block 42 allow data to be exchanged from one board 50 to other boards.

One drawback of the optical backplane scheme in FIG. 3 is that as the interconnect scale becomes larger, using a centralized adapter block (e.g., patch panel block 42) can create crowding issues. Many optical fibers become densely packed around one location, making the design of the adapter block very difficult to safeguard connection quality and reliability.

### SUMMARY

An optical shuffle cable comprises a first cable section, a second cable section, and an intermediate cable section between the first and second cable sections. The first cable section includes a plurality of optical fibers formed as a plurality of first optical fiber ribbons. The plurality of first optical fiber ribbons are stacked to arrange the plurality of optical fibers of the first cable section in a first array. The second cable section includes a plurality of optical fibers formed as a plurality of second optical fiber ribbons. The plurality of second optical fiber ribbons are stacked to arrange the plurality of optical fibers of the second cable section in a second array. The first and second arrays have respective first and second orientations that are perpendicular to each other such that the plurality of first optical fiber ribbons and the plurality of second optical fiber ribbons are shuffled between the first and second orientations within the intermediate cable section.

Additional features and advantages will be set forth in the detailed description which follows, and in part will be readily apparent to those skilled in the technical field of optical communications. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic diagram an example of a Clos network.

FIG. 2 is a schematic view of one embodiment of an optical backplane in an exemplary environment, wherein the optical backplane is designed to carry out an optical shuffle.

FIG. 3 is a perspective view of another embodiment of an optical backplane for carrying out an optical shuffle.

FIG. 4 is a schematic drawing of a portion of an exemplary shuffle cable according to one embodiment of this disclosure.

FIG. 5 is a perspective view, with schematic diagrams, of one embodiment based on the principle schematically shown in FIG. 4.

FIG. 6 is a perspective view showing an optional feature of the shuffle cable of FIG. 5.

FIG. 6A is a close-up perspective view a portion of the shuffle cable of FIG. 5.

FIGS. 7 and 8 are schematic views of two different exemplary uses of shuffle cables according to the present disclosure.

FIG. 9 is a perspective view of a shuffle cable according to another embodiment of the present disclosure.

FIG. 10 is a perspective view illustrating one example of how shuffle cables according to the present disclosure may be formed.

FIGS. 10A and 1013 are schematic perspective views different cable sections of the shuffle cable being formed in FIG. 10.

FIG. 11 is a perspective view illustrating another example of how shuffle cables according to the present disclosure may be formed.

FIG. 12 is a schematic view illustrating how smaller shuffle cables may be used to form a combined shuffle cable.

FIG. 13 is a perspective view of one embodiment based on the principle shown in FIG. 12.

FIG. 13A is an enlarged perspective view of a portion of the embodiment of FIG. 13.

FIG. 14 is a schematic view illustrating how smaller shuffle cables may be used to form a combined shuffle cable having an asymmetrical arrangement.

FIG. 15 is a perspective view of one embodiment based on the principle shown in FIG. 14.

FIGS. 15A and 15B are enlarged perspective views of different portions of the embodiment of FIG. 15.

FIG. 16 is a perspective view of the embodiment of FIG. 15, illustrating one example of how shuffle cables may be linked/coupled together to form the combined shuffle cable.

FIG. 17 is schematic cross-sectional view taken along line A-A in FIG. 16. and cross-sectional

FIGS. 18 and 19 are schematic views further illustrating how shuffle cables may be linked/coupled together to form a combined shuffle cable.

### DETAILED DESCRIPTION

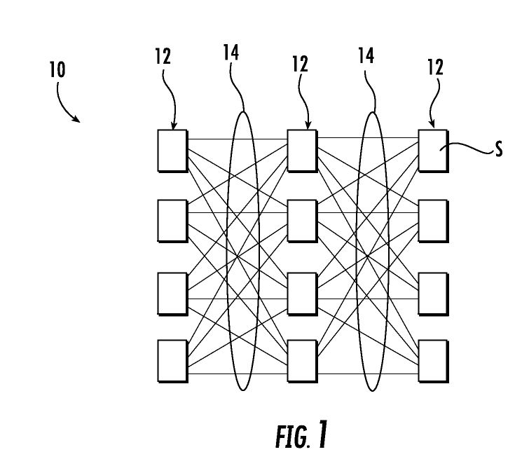

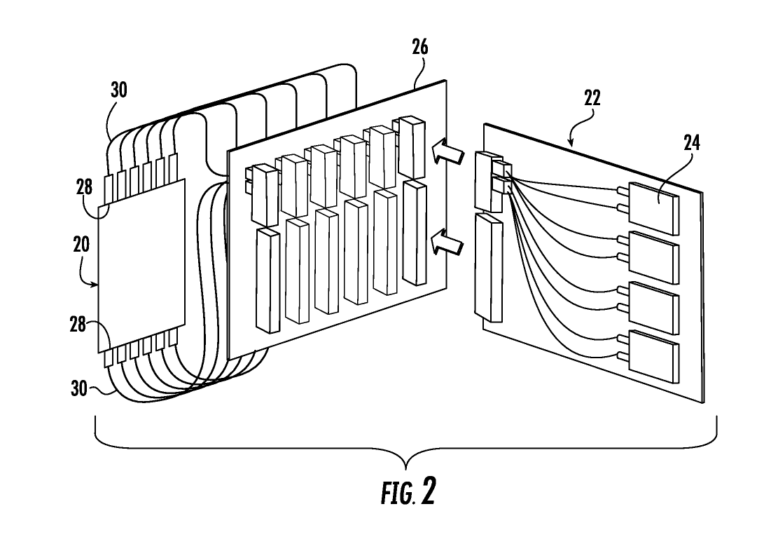

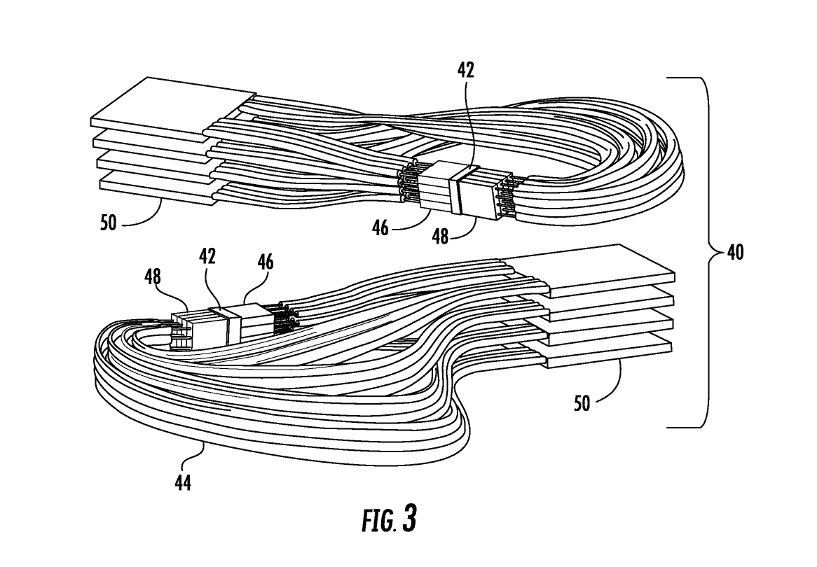

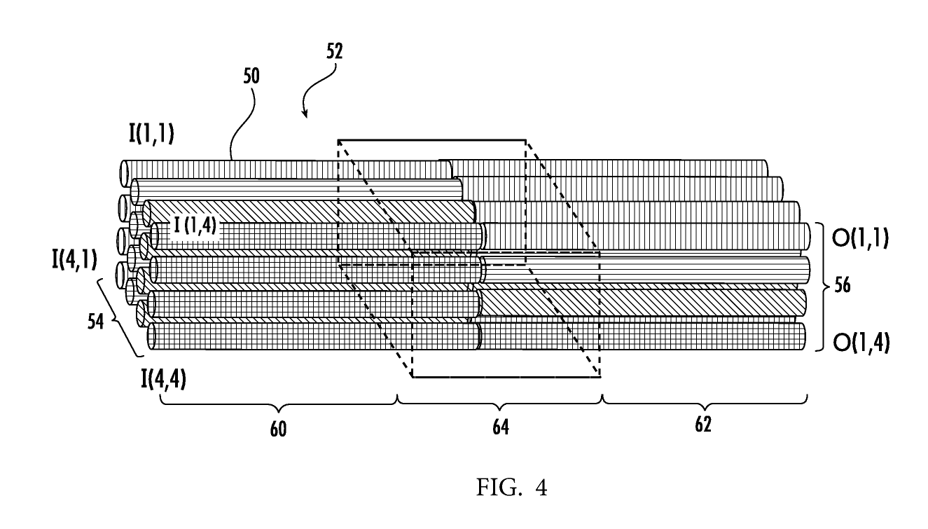

This disclosure presents new ways to map the shuffle pattern of a Clos network into an array with a highly regular pattern of interconnects. Such a mapping is shown in FIG. 4, the principle upon which the techniques of this disclosure are based. FIG. 4 is a 3D version of the shuffles 14 of FIG. 1, but each line in FIG. 3 is now represented as an optical fiber 50 (“fiber 50”) in FIG. 4. Additionally, the optical fibers 50 are part of a shuffle cable 52 (“cable 52”), as will be described in greater detail below. Sections of the cable in FIG. 4 include 16 of the optical fibers 50 arranged in a 4×4 array. More specifically, on the left side of the rectangular block in FIG. 4, all of the optical fibers 50 are labeled as inputs I and indexed to be I(1,1), I(1,2), I(2,1), I(2,2) all the way to I(4, 3), I(4.4). These 16 optical fibers on the left side of the rectangular block are arranged as 4 rows of 4 optical fibers that may be ribbonized horizontally to form four rows of four-fiber ribbons 54 (“input ribbons 54” or “first optical fiber ribbons 54”). Thus, the input ribbons 54 are stacked horizontally (i.e., oriented horizontally and on top of each other) to define the 4×4 array. The four optical fibers 50 in each of the input ribbons 54 may have four distinctive colors, as represented by different cross-hatching in FIG. 4. On the right side of the rectangular block in FIG. 4, the 16 optical fibers are labeled as outputs O and indexed as O(1,1), O(1,2), . . . O(2,1), O(2,2) . . . all the way to O(4,3), O(4.4). The optical fibers 50 on the right side of the rectangular box may be ribbonized vertically to form four columns of four-fiber ribbons 56 (“output ribbons 56” or “second optical fiber ribbons 56”). Thus, the output ribbons 56 are stacked vertically (i.e., oriented vertically and beside each other rather than on top of each other) to define the 4×4 array.

As can be appreciated, the input ribbons 54 and output ribbons 56 have respective first and second orientations that are perpendicular to each other. The term “perpendicular” in this disclosure refers to being generally transverse, such as at an angle between 75 and 105 degrees, so as not to be limited to exactly at 90 degrees. Within the rectangular block, the input ribbons 54 and output ribbons 56 are shuffled between the first and second orientations. The term “shuffled” or “shuffle” or “shuffling” in this disclosure refers to a switch in interconnect patterns so that M groups of N optical inputs are each optically linked to N groups of M optical outputs. This switch may occur in a variety of different ways, some examples of which are described in further detail below. The input ribbons 54 may, for example, be fusion spliced to the output ribbons 56. Alternatively, the optical fibers 50 from the input ribbons 54 may be in loose (i.e., non-ribbonized form) within the rectangular block, re-arranged to the interconnect pattern associated with the second orientation, and then ribbonized to form the output ribbons 56. Regardless of how the shuffle is achieved, when the input ribbons 54 are linked to the group of switches S (see FIG. 1) of one of the stages 12 (e.g., each of the input ribbons 54 being coupled to a respective one of the switches S), and when the output ribbons 56 are linked to the group of switches S of an adjacent stage 12, one of the shuffles 14 in FIG. 1 is realized using the cable 52 of FIG. 4.

As schematically shown in FIG. 4, the cables 52 comprise a first cable section 60 and a second cable section 62 each having optical fiber ribbons (the input ribbons 54 and output ribbons 56, respectively, in the embodiment shown) that are stacked, with the optical fiber ribbons of the first and second cable sections 60, 62 being oriented perpendicular to each other. The rectangular block in the middle of FIG. 4 may represent an intermediate cable section 64 between first and second cable sections 60, 62. The intermediate cable section 64 may comprise a housing, body, block, or the like that helps protect ends of the optical fiber ribbons. Alternatively, the intermediate cable section 64 may comprise a jacket surrounding the ends of the optical fiber ribbons.

FIG. 5 illustrates one embodiment of a shuffle cable 70 (“cable 70”) based on the principles of FIG. 4. The cable 70 is an example embodiment of the cable 52 in FIG. 4 such that the same reference numbers from FIG. 4 are used in FIG. 5 to refer to corresponding elements. In this embodiment, the intermediate cable section 64 comprises a rigid mechanical enclosure 72 (also referred to as “box 72”) that protects starting/ending points of the input ribbons 54 and the output ribbons 56. There is a boot 76 on each side of the enclosure 72 to help transition from rigid to flexible portions of the cable 70 (e.g., the first cable section 60 and the second cable section 62). Four ribbons extending from each side of the enclosure 72, i.e. the four input ribbons 54 and the four output ribbons 56, are oriented perpendicular to each other. The first cable section 60 comprises a first cable jacket 80 to surround at least some length of the input ribbons 54, and the second cable section 62 comprises a second cable jacket 82 to surround at least some length of the output ribbons 56. To help manage ribbons inside the cable 70, there may be adhesive between each layer of the ribbons, but with the adhesive still allowing the ribbons to be separated without damaging individual ribbons or optical fibers.

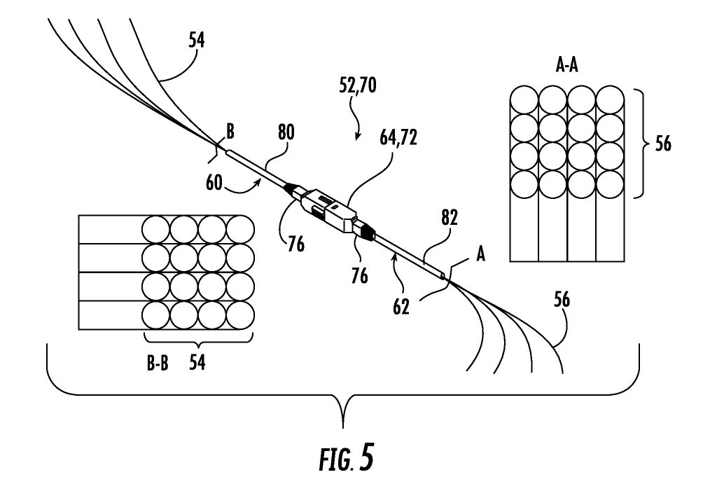

FIGS. 6 and 6A further show the feature of peelability of ribbons so that the cable 70 can be used in distributed interconnect applications easily. In FIG. 6A, one output ribbon 56₁ (or “layer” of the associated ribbon stack) is peeled from the other three ribbons (56₂₋₄) to link to a nearby location. The same may done with respect to a first input ribbon 54₁ (FIG. 6). The other three associated ribbons (54₂₋₄ or 56₂₋₄) continue as a group until the next ribbon layer (54₂ or 56₂) is separated to link to a different location, at which point the other two ribbons (54_{3,4} or 56_{3,4}) continue as group before being separated themselves. Each of the input ribbons 54 and output ribbons 56 in this embodiment is terminated with an array connector 84, such as an MPO connector, such that the cable 70 is part of a cable assembly 90.

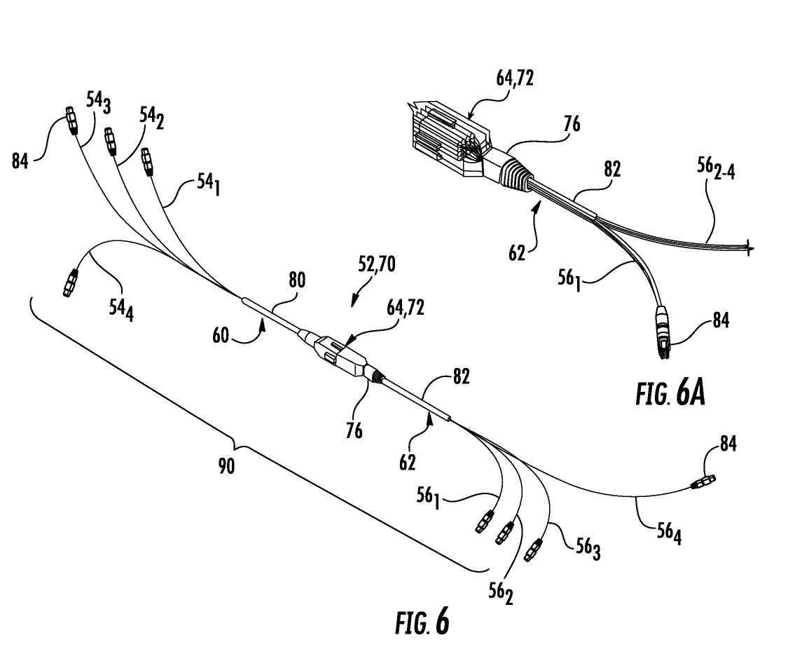

One application of optical shuffle cables according to this disclosure may be for the type of optical backplane shown in the system of FIG. 7. Due to the peelable nature of the cable 70 (FIG. 6; represented generically by cable 52 in FIG. 7), one can place and mount the intermediate cable section 64 (e.g., the enclosure 72) of the cable 52 to a convenient location on a backplane 100 as shown; the backplane 100 may be within a cabinet system (not shown). All computing boards 102 where optical parallel fiber ports are located can be linked through routing of the input ribbons 54 and output ribbons 56 to the right port locations. Each input ribbon 54 and output ribbon 56 is terminated by a respective array connector 84 (e.g., an MPO connector), and can be formed to have different lengths after a routing design is determined, making this approach very flexible to fit various environments and to be used for general purposes.

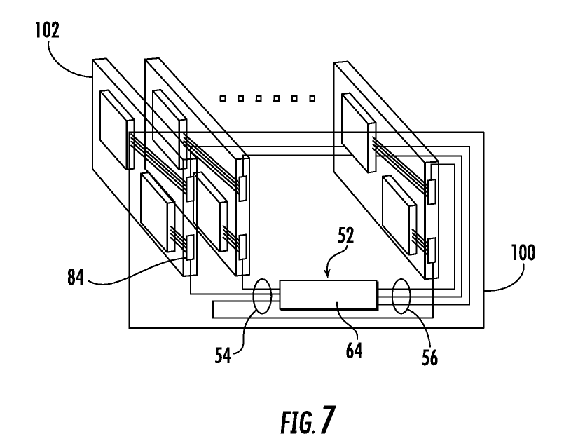

As shown in FIG. 8, the same concept can also be applied to linking multi-process shelves 110 instead of just computing boards. Again, the intermediate cable section 64 of the cable 52 is mounted at a convenient location within a cabinet system. The first and second cable sections 60, 62 can then be routed along an interior wall of the cabinet system, with the input ribbons 54 and output ribbons 56 branching off as needed (e.g., peeling away from the other associated ribbons) to link to desired locations on the shelves 110.

To assemble the cable 52, and as schematically shown in FIGS. 5 and 9, one method may involve first forming the stacks of input ribbons 54 and output ribbons 56, with the stack of the input ribbons 54 and the stack of the output ribbons 56 being oriented perpendicular to each other. The input ribbons 54 and output ribbons 56 of each stack may be introduced from two opposite sides of a fusion splicer (not shown). Each pair of aligned optical fibers 50 is then spliced using the fusion splicer and appropriately protected (e.g., by either a re-jacketing/recoating process or by a splicing protection tube 114 applied over the splice joint(s)). The spliced optical fibers are then placed in the enclosure 72, which can be filled with curable adhesive to ensure all spliced fiber joints are environmentally protected. FIG. 9 also illustrates the boots 76 on opposed sides of the enclosure 72 to help protect the stacks of input ribbons 54 and output ribbons 56 extending from the opposed sides, and to help the input ribbons 54 and output ribbons 56 withstand side pull forces.

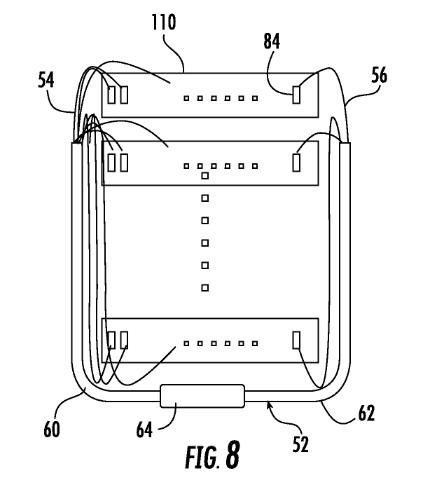

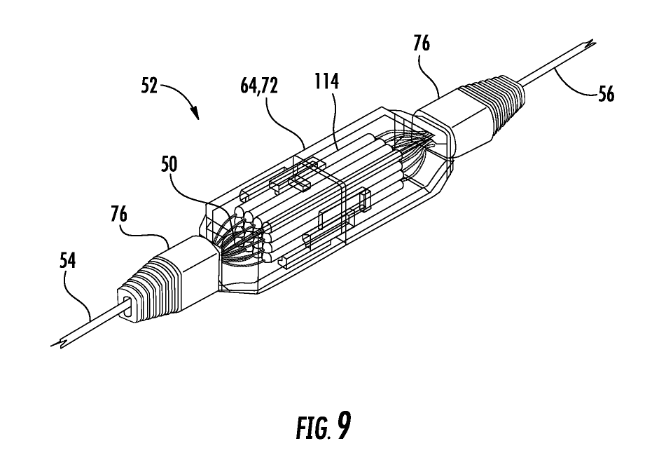

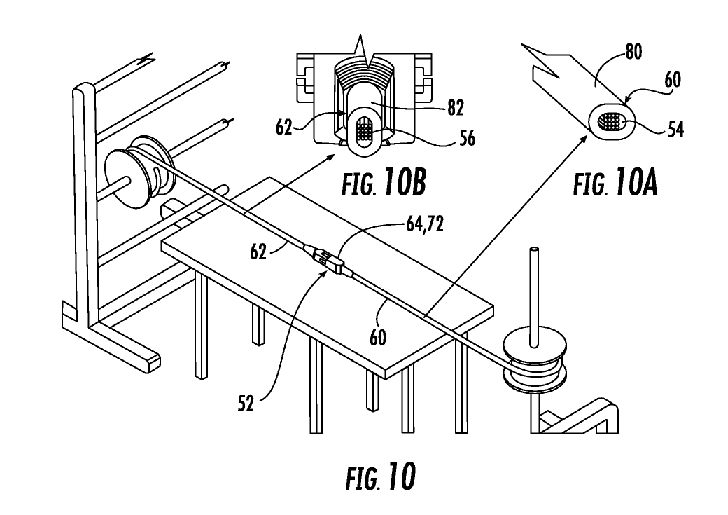

After the stacks of the input ribbons 54 and output ribbons 56 are formed, conventional cable-making processes may be followed to complete the first cable section 60 and second cable section 62. As shown in FIG. 10, this includes adding the first cable jacket 80 over at least some length of the input ribbons 54 and the second cable jacket 82 over at least some length of the output ribbons 56. Features allowing the input ribbons 54 or output ribbons 56 to be peeled or otherwise branched off can be accommodated during this process. Thus, a mesh material or the like may extend over at least some length of the input ribbons 54 or output ribbons 54, after the first cable jacket 80 or second cable jacket 82.

Another method to make optical shuffle cables according to this disclosure does not involve splices between optical fibers. FIG. 11 illustrates some basic principles of one such splice-free method. Again, the cable 52 will comprise stacks of the input ribbons 54 and output ribbons 56 having orientations perpendicular to each other (see e.g., FIG. 4). One end of these stacks fiber ribbons (e.g., the output ribbons 56 of the second cable section 62 in FIG. 11) can be made in a conventional way, e.g. by threading the multiple optical fibers 50 (FIG. 4) into a ribbonization fixture 120 that positions the optical fibers 50 next to another when being pulled through an adhesive fixture 122, where UV curable epoxy or the like is uniformly applied to the groups of optical fibers. The adhesive fixture 122 may also have a UV curing area. When the groups of optical fibers with adhesive applied thereto pass through the UV curing area, the adhesive is cured so that the output ribbons 56 are formed. The output ribbons 56 may be formed to have a length that is approximately one half of the total contemplated length for the cable 52. The ribbonization process then stops, with loose fiber ends still remaining still on their associated, individual fiber reels 124 (not being truncated). Also, once sufficient lengths of the output ribbons 56 have been formed for one side of the cable 52, steps can be taken to make the output ribbons peel-able or otherwise able to branch off/break away from each other by adding pressure sensitive adhesive between the output ribbons 56. Additionally, the second cable jacket 82 may be formed to surround the output ribbons 56.

As already noted, the opposite side of the cable 52 is still in loose fiber form. The loose optical fibers 50 may be guided or otherwise rearranged into an array consistent with the first cable section 60 in FIG. 4. Once rearranged, the optical fibers 50 may be guided through the ribbonization fixture 120 and pulled through the adhesive fixture 122 to form the input ribbons 54. Using this method, there is no splicing involved and, therefore, no recoating or splice protection is needed. The optical fibers 50 of the output ribbons 56 are simply extensions of the optical fibers 50 of the input ribbons 54.

It is possible that the midsection where the ribbon stacks of the first and second cable sections 60, 62 change their formations can be squeezed into a flexible cable, although it may still be desirable to still protect these switching points or regions with a rigid tube enclosure filled with epoxy or another adhesive.

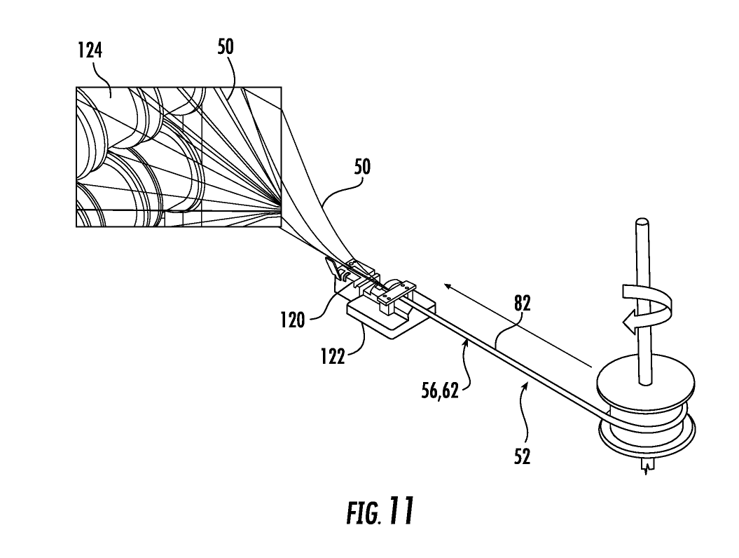

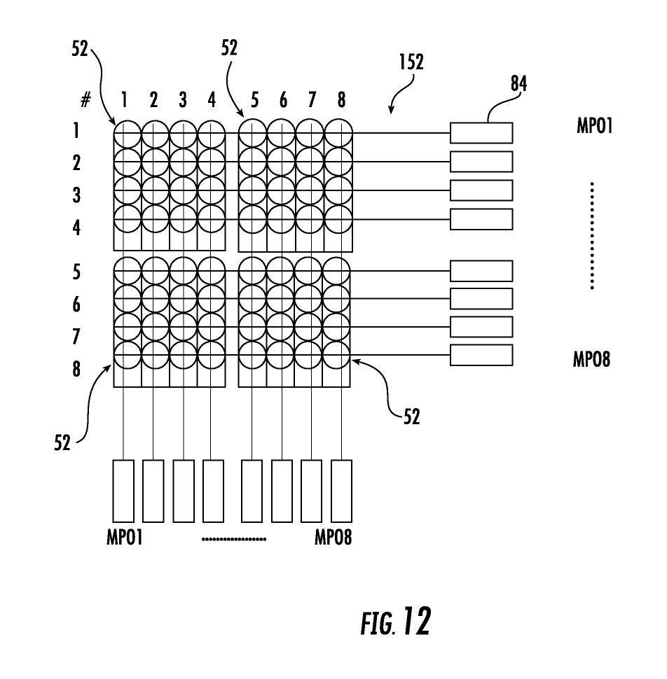

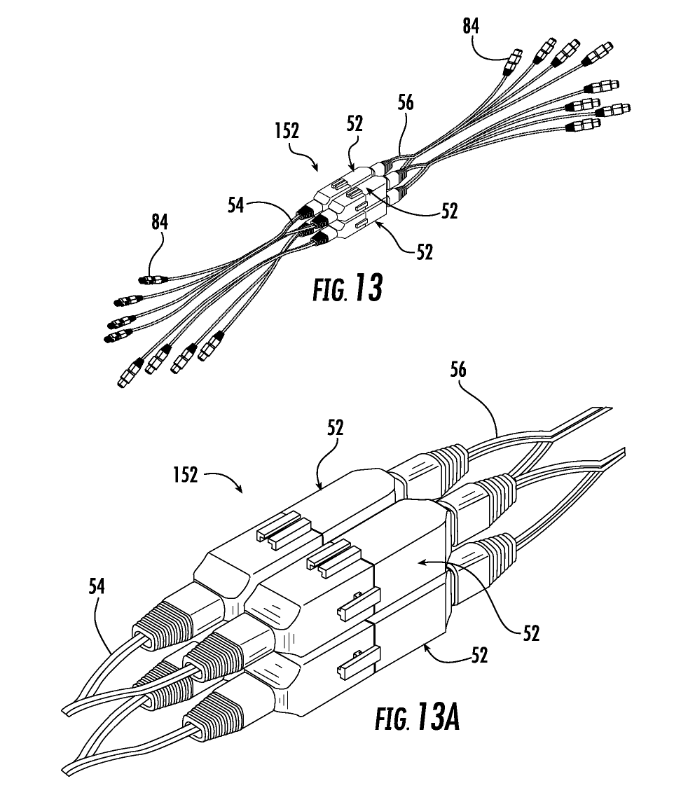

Another feature of this disclosure is that one can bundle smaller scale shuffle cables to form larger ones (a “combined shuffle cable”). Two examples are shown in FIGS. 12 and 13 (first example) and FIGS. 14-16 (second example).

In the example of FIGS. 12, 13, and 13A, a larger 8×8 shuffle cable 152 is formed using four pieces/units of 4×4 shuffle cable 52. The bundling process is a simple and straightforward process as explained using FIG. 12, which schematically illustrates the fiber cross-section of the 8×8 shuffle cable 152. Instead of using larger ribbons to make the 8×8 shuffle, eight fibers of each of the four layers of fiber ribbons coming out of the top two 4×4 shuffle cables are used to feed an associated MPO connector 84. This process repeats itself until all eight MPO connectors are terminated (see right side of FIG. 12). On the other side of the midsection box, ribbons are combined vertically, also for all 8 fiber ribbon columns. A 3D version of the MPO connectorized 8×8 shuffle cable 152 made by the four bundled 4×4 shuffle cables 52 is shown in FIG. 13.

FIGS. 14-16, 16A, and 16B illustrate one example of how to make an asymmetric shuffle cable 252, e.g. 8×12 based on stacking of smaller scale shuffle cables 52. In the embodiment shown, six pieces/units of 4×4 shuffle cables 52 are used to make the 8×12 combined shuffle cable 252. The principle can be best seen in FIG. 14. The only difference from the previous example (FIG. 12) is that on one side, MPO termination for twelve fibers is done by threading four fibers each of three midsection boxes 72 into a ferrule of the MPO connector 84. One the other hand, the MPO connector 84 for cable connections from the other side of the cables use fibers coming out of two of the boxes 72. Similarly, a 3D view of a MPO-terminated combined 8×12 shuffle cable that is based on 4×4 shuffle cables is shown in FIG. 15.

As an example, using M×M shuffle cables where M is an integer >1, one can form an L×L scale combined shuffle cable where L=P×M where P is an integer >1. A total of P² M×M shuffle cables are needed for such a combined shuffle cable. One can also form asymmetric shuffle cables and asymmetric combined shuffle cables.

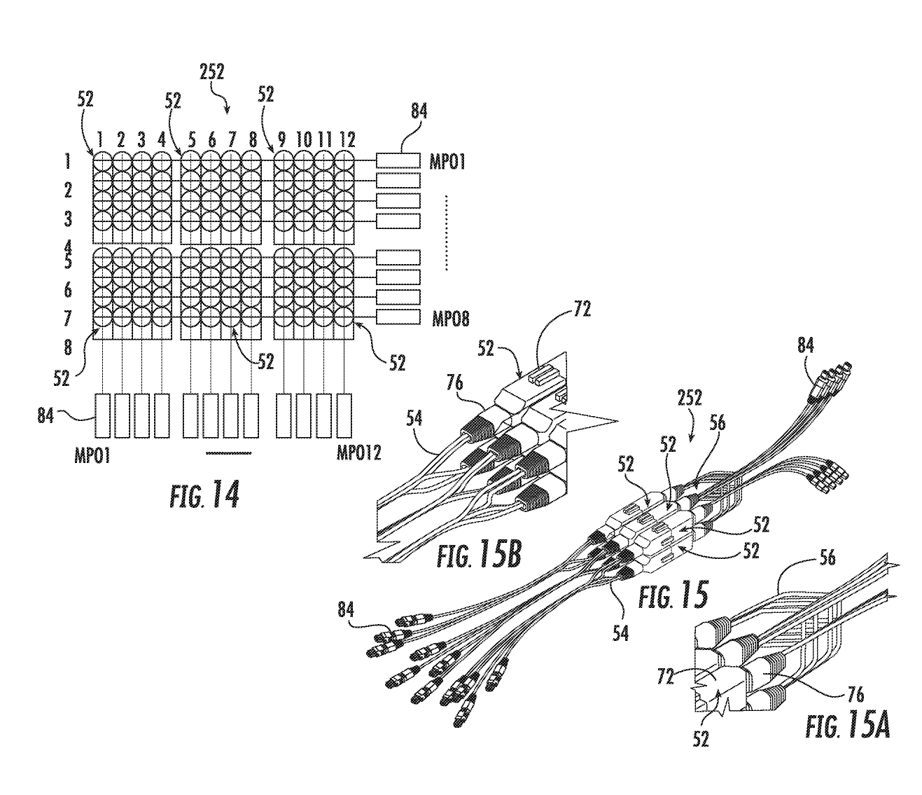

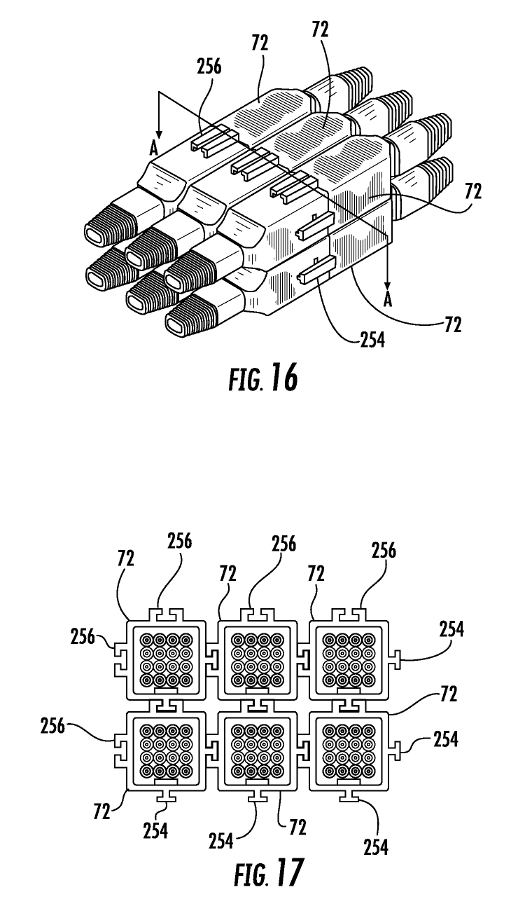

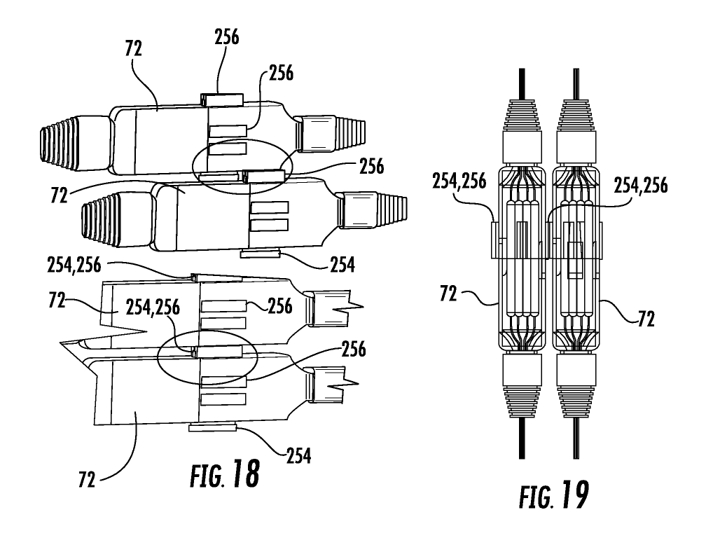

To make sure the stacked array of midsection boxes 72 in a combined shuffle cable is stable in the bundled application, each of the four sides of the midsection box 72 may have interlocking features (e.g., an interconnect clips) as part of or attached to the box exterior. The interlocking features can be used to link adjacent boxes 72. FIGS. 16 and 17 show a method of connecting six cable boxes 72 for a 2×3 matrix of shuffles to form a 8×12 bundled shuffle cable 252 (FIGS. 14 and 15). Each of the four sides of each box 72 has either a male interlocking feature 254 or female interlocking feature 256 which mates in a slide-in fashion with the opposite gender. FIGS. 18 and 19 show details of the male and female interlocking features 252, 254 that can only be connected in a unidirectional slide-in fashion to prevent from mistakenly connecting cables in a reverse direction.

Those skilled in optical connectivity will appreciate that modifications and variations can be made without departing from the spirit or scope of the invention defined by the claims below. This includes modifications, combinations, sub-combinations, and variations of the disclosed embodiments.

What is claimed is:

1. An optical shuffle cable, comprising:
a first cable section including a plurality of optical fibers formed as a plurality of first optical fiber ribbons;
a second cable section including a plurality of optical fibers formed as a plurality of second optical fiber ribbons; and
an intermediate cable section between the first cable section and the second cable section;
wherein:
the plurality of first optical fiber ribbons are stacked to arrange the plurality of optical fibers of the first cable section in a first array;
the plurality of second optical fiber ribbons are stacked to arrange the plurality of optical fibers of the second cable section in a second array; and
the first and second arrays have respective first and second orientations that are perpendicular to each other such that the plurality of first optical fiber ribbons and the plurality of second optical fiber ribbons are shuffled between the first orientation and the second orientation within the intermediate cable section.

2. The optical shuffle cable of claim 1, wherein the plurality of optical fibers of the first cable section are fusion spliced to the plurality of optical fibers of the second cable section within the intermediate cable section.

3. The optical shuffle cable of claim 1, wherein the plurality of optical fibers in the second cable section are extensions of the plurality of optical fibers in the first cable section.

4. The optical shuffle cable of claim 1, wherein:
the first array comprises M rows of the first optical fiber ribbons each having N of the plurality of optical fibers of the first cable section (M×N array);
the second array comprises N rows of the second optical fiber ribbons each having M of the plurality of optical fibers of the second cable section (N×M array); and
wherein N and M are integers, and wherein N≥4.

5. The optical shuffle cable of claim 4, wherein M≠N.

6. The optical shuffle cable of claim 4, wherein M≥N.

7. The optical shuffle cable of claim 1, wherein the intermediate cable section comprises a housing having a first end from which the first cable section extends and a second end from which the second cable section extends such that the plurality of optical fibers of the first cable section and the plurality of optical fibers of the second cable section are shuffled between the first and second orientations within the housing.

8. The optic shuffle cable of claim 7, wherein the plurality of first optical ribbons and the plurality of second optical fiber ribbons extend into the housing at least some length, and wherein the plurality of optical fibers that form the plurality of first optical fiber ribbons and the plurality of optical fibers that from the plurality of second optical fiber ribbons each have at least some length that is not ribbonized within the housing.

9. The optical shuffle cable of claim 7, wherein the housing includes an exterior between the first and second ends of the housing, the optical shuffle cable further comprising:
at least two first interlocking members and at least two second interlocking members distributed around the exterior of the housing, wherein the at least two first interlocking members and the at least two second interlocking members are arranged such that each of the at least two first interlocking members is opposite one of the at least two second interlocking members, and wherein each of the at least two first interlocking members is shaped for engagement with each of the at least two second interlocking members.

10. The optical shuffle cable of claim 9, wherein the at least the at least two first interlocking members and the at least two second interlocking members are integrally formed with the housing as a monolithic structure.

11. The optical shuffle cable of claim 9, wherein the housing has a longitudinal axis extending between the first and second ends, and wherein the housing has a substantially rectangular cross-section in a plane transverse to the longitudinal axis where the at least two first interlocking members and the at least two second interlocking members are located on the exterior of the housing.

12. The optical shuffle cable of claim 9, wherein each of the at least two first interlocking members defines a key, and wherein each of the at least two second interlocking members defines a keyway shaped to receive and retain one of the keys.

13. The optical shuffle cable of claim 12, wherein the keyway comprises a C-Shaped channel.

14. The optical shuffle cable of claim 9, wherein each of the at least two first interlocking members is shaped for engagement with each of the at least two second interlocking members in only one direction.

15. The optical shuffle cable of claim 1, wherein the first cable section includes a first cable jacket surrounding at least some length of the plurality of optical fibers in the first cable section, and wherein the second cable section includes a second cable jacket surrounding at least some length of the plurality of optical fibers in the second cable section.

16. An optical shuffle cable, comprising:
a first cable section including a plurality of first optical fiber ribbons;
a second cable section including a plurality of second optical fiber ribbons,
a housing having a first end from which the first cable section extends and a second end from which the second cable section extends, wherein the plurality of first optical fiber ribbons and the plurality of second optical fiber ribbons are arranged in respective first and second arrays at the respective first and second ends of the housing, and wherein the first and second arrays have respective first and second orientations that are perpendicular to each other such that optical fibers of the first and second optical fiber ribbons are shuffled between the first and second orientations within the housing.

17. The optical shuffle cable of claim 16, wherein the housing comprises a first housing component including the first end of the housing and a second housing component including the second end of the housing, and wherein the first housing component is coupled to the second housing component to provide an enclosure in which the optical fibers of the first and second optical fiber ribbons are shuffled.

18. The optical shuffle cable of claim 16, wherein the housing includes an exterior between the first and second ends of the housing, the optical shuffle cable further comprising:
at least two first interlocking members and at least two second interlocking members distributed around the exterior of the housing, wherein the at least two first interlocking members and the at least two second interlocking members are arranged such that each of the at least two first interlocking members is opposite one of the at least two second interlocking members, and wherein each of the at least two first interlocking members is shaped for engagement with each of the at least two second interlocking members.

19. An optical shuffle cable, comprising:
a housing having opposed first and second ends;
a first cable section extending from the first end of the housing and including a plurality of first optical fiber ribbons that each have N optical fibers; and
a second cable section extending from the second end of the housing and including a plurality of second optical fiber ribbons that each have M optical fibers;
wherein:
the plurality of first optical fiber ribbons are stacked at least at the first end of the housing as M rows of the N optical fibers to define an M×N array;
the plurality of second optical fiber ribbons are stacked at least at the second end of the housing as N rows of the M optical fibers to define an N×M array; and
the M×N array and N×M array have respective first and second orientations that are perpendicular to each other.

20. The optical shuffle cable of claim 19, wherein M≠N.
